(19) United States
(12) Patent Application Publication
(10) Pub. No.: US 2010/0253824 A1
(43) Pub. Date: Oct. 7, 2010

(54) DIGITAL PHOTO FRAME

(75) Inventors: MING-TESUNG CHENG, Tu-Cheng (TW); CHIUNG-LI CHANG, Tu-Cheng (TW); LI-ZHANG HUANG, Tu-Cheng (TW); TE-YUAN KUNG, Tu-Cheng (TW); HAN-CHE WANG, Tu-Cheng (TW); CHENG-HAO CHOU, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/631,848

(22) Filed: Dec. 6, 2009

(30) Foreign Application Priority Data
Apr. 1, 2009 (CN) 200910301271.X

(51) Int. Cl. H04N 5/222; H04N 5/64

(52) U.S. Cl. 348/333.01; 348/E05.022; 348/836; 348/E05.128

(57) ABSTRACT

A digital photo frame (DPF) includes a main body, a supporting member, a holding member, and an image capturing member. The main body includes a storage unit and a display unit. The supporting member is connected to the main body for receiving a paper printed photo. The holding member is rotatably connected to the main body.

The image capturing member is mounted on a bottom surface of the holding member. When the holding member is kept in an open position, the image capturing member is activated to capture an image of the paper printed photo received in the supporting member, and the captured image of the paper printed photo is transmitted to be stored in the storage unit and to be displayed on the display unit.

### BACKGROUND

1. Technical Field

The present disclosure relates to digital photo frames and, particularly, to a digital photo frame capable of capturing and displaying images of paper printed photos.

2. Description of Related Art

Although digital cameras have all but replaced conventional cameras, a plurality of photos printed on photo sensitive papers are still reserved by consumers. Typically, in order to display the images of these photos using digital photo frames, consumers have to use a scanner, which is convenient and expensive and may further involve external storage devices.

### BRIEF DESCRIPTION OF THE DRAWINGS

The components of the drawings are not necessarily drawn to scale, the emphasis instead being placed upon clearly illustrating the principles of a digital photo frame. Moreover, in the drawings, like reference numerals designate corresponding parts throughout several views.

FIG. 1 is a side view of the digital photo frame in accordance with an exemplary embodiment.

FIG. 2 is a block diagram of the hardware structure of the digital photo frame of FIG. 1.

FIG. 3 is an isometric view of the digital photo frame of FIG. 1.

FIG. 4 is an isometric view of the digital photo frame in accordance with another exemplary embodiment.

### DETAILED DESCRIPTION

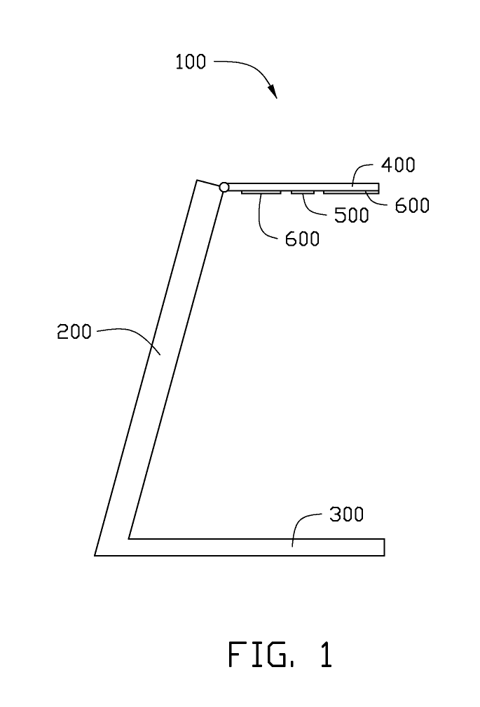

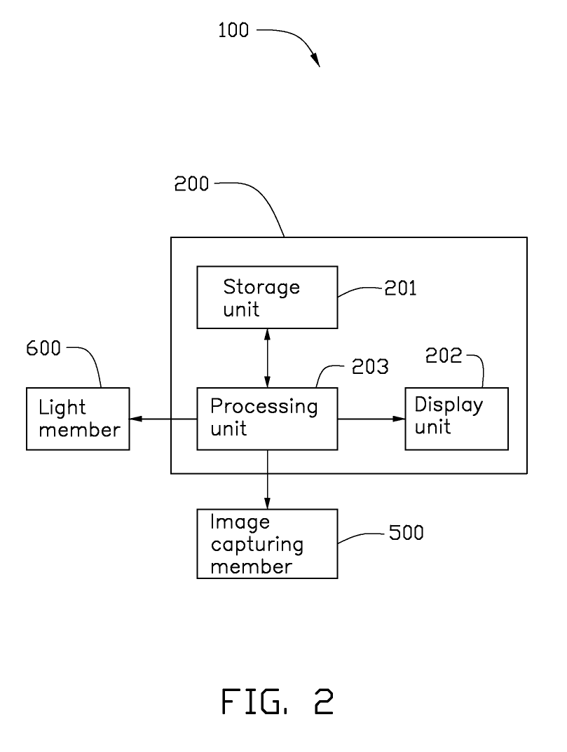

Referring to FIGS. 1-2, an embodiment of a digital photo frame (DPF) 100 is illustrated. The DPF 100 includes a main body 200, a supporting member 300, a holding member 400, an image capturing member 500, and at least one light member 600.

The main body 200 includes a storage unit 201, a display unit 202, and a processing unit 203. The storage unit 201 is configured to store digital images. The display unit 202 is configured to display the digital images. The processing unit 203 is configured to control the operation of the DPF 100.

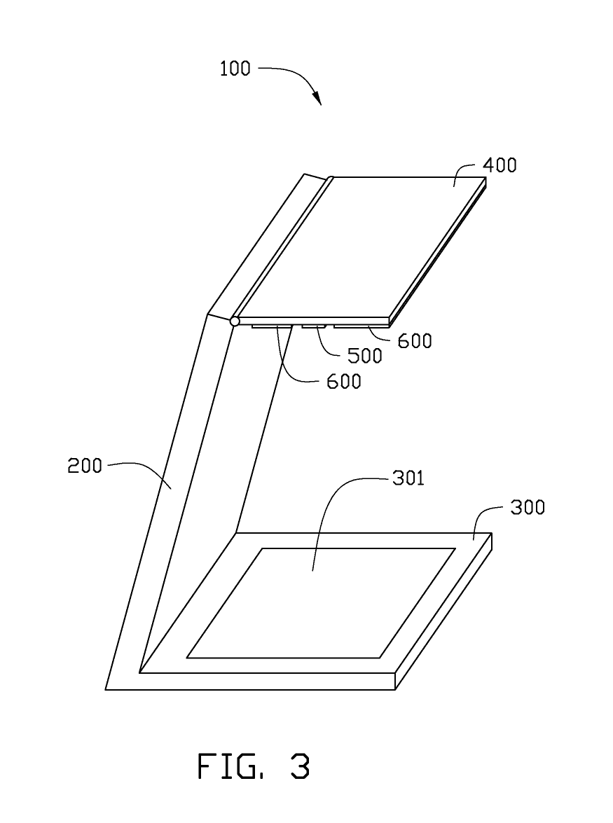

Referring also to FIG. 3, in the embodiment, the supporting member 300 is secured to the bottom of the main body 200. In an alternative embodiment, the supporting member 300 can be rotatably connected to the bottom of the main body 200. A recessed portion 301 is formed on the top surface of the supporting member 300 for receiving a paper printed photo. In the embodiment, the recessed portion 301 is substantially square. A transparent panel (not shown) can also be employed to cause the paper printed photo received in the recessed portion 301 to be in a flat state.

The holding member 400 is rotatably connected to the top of the main body 200. The holding member 400 can be rotated from a closed position to an open position. When in the closed position, the holding member 400 and the main body 200 are in surface to surface contact. When in the open position, the holding member 400 is substantially parallel with the bottom surface of the recessed portion 301. An electrical lead (not shown) is disposed within the holding member 400.

The image capturing member 500 is mounted on the holding member 400 for capturing an image of the paper printed photo received in the recessed portion 301. The image capturing member 500 is electrically connected to the processing unit 203 via the lead within the holding member 400. When the holding member 400 is in the open position, the image capturing member 500 can be activated to capture the image of the paper photo received in the recessed portion 301. In the embodiment, the image capturing member 500 is a camera.

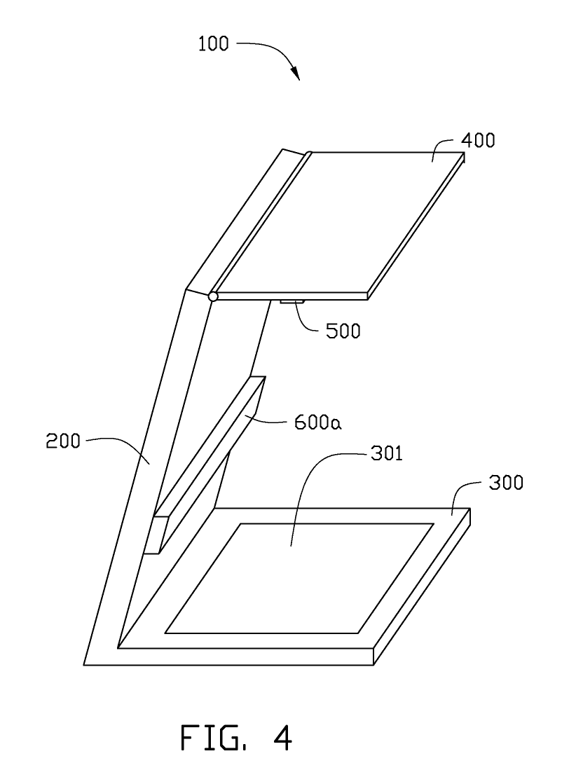

The at least one light member 600 is configured to provide enough lightning during the operation of the image capturing member 500 to ensure the quality of the captured image of the paper printed photo. In the embodiment, a pair of light members 600 is mounted on the holding member 400. The image capturing member 500 is disposed between the light members 600. In an alternative embodiment, a light element 600a is mounted on the back of the main body 200 facing the recessed portion 301 (see FIG. 4).

When in use, a paper printed photo is disposed in the recessed portion 301. The holding member 400 is rotated from the closed position to the open position, and the image capturing member 500 is activated to capture an image of the paper printed photo. During the operation of the image capturing member 500, the light members 600 are activated to provide enough lightning to ensure the quality of the captured image of the paper printed photo. The captured image of the paper printed photo is transmitted to be stored in the storage unit 201, and can be displayed on the display unit 202.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A digital photo frame (DPF) comprising:
a main body comprising a storage unit and a display unit;
a supporting member connected to the main body for receiving a paper printed photo;
a holding member rotatably connected to the main body; and
an image capturing member mounted on a bottom surface of the holding member;
wherein when the holding member is kept in an open position, the image capturing member is activated to capture an image of the paper printed photo received in the supporting member, and the captured image of the paper printed is transmitted to be stored in the storage unit and to be displayed on the display unit.

2. The DPF as described in claim 1, wherein at least one light member is mounted on the bottom surface of the holding member for providing enough lightning during the operation of the image capturing member.

3. The DPF as described in claim 2, wherein the at least one light member is a pair of light members mounted on the bottom surface of the holding member, and the image capturing member is disposed between the light members.

4. The DPF as described in claim 1, wherein at least one light element is mounted on the back of the main body opposite to the display unit for providing enough lightning during the operation of the image capturing member.

5. The DPF as described in claim 1, wherein a recessed portion is formed on the top surface of the supporting member for receiving the paper photo.

6. The DPF as described in claim 5, wherein the recessed portion is square.

7. The DPF as described in claim 5, wherein when the holding member is in the open position, the bottom surface of the holding member is substantially parallel with the bottom surface of the recessed portion.

8. The DPF as described in claim 1, wherein the supporting member is secured to a bottom of the main body.

9. The DPF as described in claim 1, wherein the supporting member is rotatably connected to a bottom of the main body.
